(19) United States
(12) Patent Application Publication
(10) Pub. No.: US 2008/0301542 A1
(43) Pub. Date: Dec. 4, 2008

(54) DIGITAL PAPER-ENABLED SPREADSHEET SYSTEMS

(76) Inventors: David McGee, Bainbridge Island, WA (US); Philipp Schmid, Mercer Island, WA (US); Ben McAllister, Seattle, WA (US); Phil Cohen, Bainbridge Island, WA (US); Michael Robin, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 12/131,848

(22) Filed: Jun. 2, 2008

Related U.S. Application Data
(63) Continuation-in-part of application No. 12/118,656, filed on May 9, 2008.
(60) Provisional application No. 60/941,332, filed on Jun. 1, 2007.

(51) Int. Cl. G06F 17/00; G06K 9/00

(52) U.S. Cl. 715/220; 382/187

(57) ABSTRACT

A digital paper-enabled system includes a spreadsheet printed on digital paper and usable with a digital writing instrument, such as a digital pen. A method of using the system includes (1) designing a digital paper-enabled spreadsheet with a spreadsheet integration module; (2) printing the designed spreadsheet to receive writing from a digital pen (3) uploading data from the digital pen to a processing system; (4) reviewing the uploaded data using a display device associated with the processing system; and (5) storing the uploaded data, which may include exporting one or more portions of the uploaded data to another display or processing system.

### FIELD OF THE INVENTION

This invention relates generally to a digital paper-enabled spreadsheet systems that operate with a digital pen used on digital paper having a digital pattern, and more specifically to an add-in module for a spreadsheet program that allows a user to utilize digital pen and paper technology to create custom spreadsheets, manipulate data and formatting in the spreadsheets, import and export data, and selectively design spreadsheet based forms.

### BACKGROUND OF THE INVENTION

Spreadsheet programs, such as Microsoft Excel®, continue to grow in popularity. Likewise, digital pen and paper technologies have also grown in popularity, yet there remains little to no integration between these two platforms. Spreadsheet programs may be used to design forms and manipulate numerous types of data.

A digital paper system includes a writing surface and a writing utensil in which the utensil knows its location in real time when it is marking on the surface. The writing surface may take the form of a digital tablet or digital paper, for example digital paper made by the Anoto Group AB and having an ANOTO® pattern. Various types of conventional digital pens include, but are not limited to, the MAXELL® digital pen, the NOKIA® digital pen, the LEAPFROG FLYFUSION® digital pen, the ANOTO® digital pen, and the LOGITECH® digital pen.

### BRIEF DESCRIPTION OF THE DRAWINGS

Preferred and alternative examples of the present invention are described in detail below with reference to the following drawings:

FIG. 1 shows a screen shot of a spreadsheet designed using a spreadsheet integration module according to an embodiment of the present invention;

FIG. 2A is screen shot of the spreadsheet integration module operating with formatting rules of a conventional spreadsheet program according to an embodiment of the present invention; and

FIG. 2B is a screen shot of a digital paper-enabled spreadsheet designed with a dropdown list obtained from a spreadsheet integration module according to an embodiment of the present invention.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, spreadsheet programs, digital paper systems, digital pens and methods for operating the same may not be shown or described in detail to avoid unnecessarily obscuring descriptions of the embodiments of the invention.

A digital paper-enabled spreadsheet system includes a spreadsheet integration module or program that cooperates with a conventional spreadsheet program such as Microsoft Excel® to design, print and review a digital paper-enabled spreadsheet. By way of example, the spreadsheet integration module is capable of (1) designing the digital paper-enabled spreadsheet, which includes digitally enabling at least one cell of the spreadsheet; (2) printing the designed spreadsheet to create a paper version of the spreadsheet that may be written on with a digital pen, for example; (3) uploading data from the digital pen to a processing system; (4) reviewing the uploaded data using a display device associated with the processing system; and (5) storing the uploaded data, which may include exporting one or more portions of the uploaded data to another system or module.

In one aspect of the invention, a digital paper-enabled spreadsheet system includes a digital paper document bearing a digital pattern. In addition, the system includes a plurality of input cells in a spreadsheet form overlaid on at least a portion of the digital pattern, a first input cell of the plurality of input cells is operable to receive handwritten information that is translatable to digital information based on processing rules associated with the first cell.

In another aspect of the invention, a method of designing a digital paper-enabled spreadsheet in cooperation with a conventional spreadsheet program includes the steps of (1) selecting a cell from a plurality of cells arranged to form the spreadsheet; (2) applying a desired formatting rule to the cell, the formatting rule selected from a set of formatting rules available from the conventional spreadsheet program; and (3) digitally enabling the cell to make the cell operable to receive written information from a digital pen, wherein digitally enabling the cell associates the written information received in the cell with a digital pattern underlying the spreadsheet after the spreadsheet is printed.

In yet another aspect of the invention, a method of processing a digital paper-enabled spreadsheet, the method includes the steps of (1) writing information in a cell of the digital paper-enabled spreadsheet with a digital writing instrument; (2) uploading the data stored in the digital writing instrument that corresponds to the written information, wherein uploading includes transmitting the written information to a computational processing system; (3) interpreting formatting rules applied to a spreadsheet from a conventional spreadsheet program, the formatting rules being previously applied to the digital paper-enabled spreadsheet during creation of the digital paper-enabled spreadsheet; (4) processing the written information using handwriting recognition software in cooperation with the formatting rules and grammar rules; and (5) converting the written information to digital information.

A spreadsheet program is a computer application used to create an electronic or hardcopy worksheet having multiple cells that together make up a grid consisting of rows and columns. Generally each cell is configured to receive alphanumeric text, numeric values, or formulas (e.g., equations), although the cells may receive other types of data as well, such as, but not limited to, images, comments, links, etc. The formula defines how the content of that cell is to be calculated from the contents of other cells. Spreadsheets are frequently used for numerical analysis because of their ability to re-calculate the entire sheet automatically after a change to a single cell.

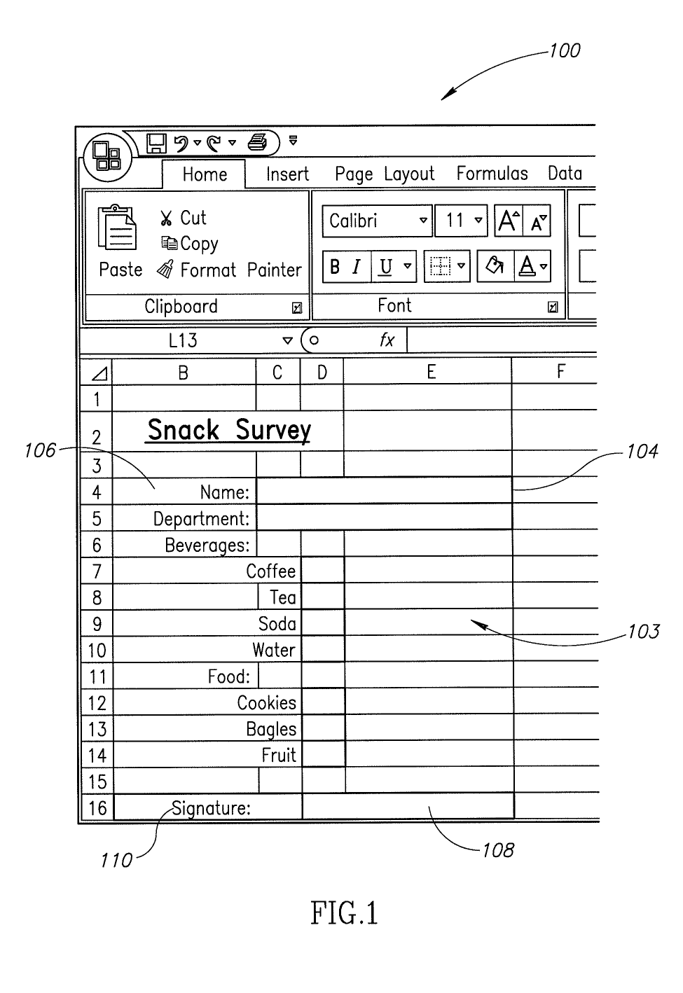

FIG. 1 shows a digital paper-enabled spreadsheet 100 designed or created using a conventional spreadsheet program in combination with a spreadsheet integration module. The spreadsheet 100 includes a plurality of cells 102 where at least one cell is a digitally-enabled cell 104 and another cell is a non-digitally-enabled cell 106 that contains data entered therein using the conventional spreadsheet program. By way of example, the non-digitally-enabled cell 106 may include a label for the digitally-enabled cell 104. The digitally-enabled cell 104 may take the form of a cell that cooperates with an underlying digital pattern of a printed spreadsheet to receive writing from a digital pen where the writing may be subsequently processed using a handwriting recognition system. The non-digitally-enabled cell 106 may take the form of a cell that even if written in will not be processed with the handwriting recognition system. For example in FIG. 1, the user may make written notes in the cell having the term “Name:,” but the written notes in that cell will not be processed by the handwriting recognition system when the data from the digital pen is uploaded to the processing system.

The spreadsheet integration module may include a number of other modules, rules, instructions, etc. For example, the spreadsheet integration module may include customized formatting and validation rules used to digitally enable the cells of the spreadsheet to receive desired types of written information and further provide the cells with instructions that are used when the written information is processed. By way of example, the spreadsheet integration module may include, but is not limited to, a signature validation module, ink checkboxes, an erasing module, a printing module, an uploading module, a review module, an evaluation module for analyzing the design of the spreadsheet, and a formatting detection module.

Designing: In the design stage, the spreadsheet integration module cooperates with the conventional spreadsheet program to take advantage and leverage the formatting features, data entry validation rules, and other aspects of the conventional spreadsheet program. In addition, the spreadsheet integration module may then be used to digitally-enable one or more cells 106 for digital pen and paper functionality. In one embodiment, the integration module seamlessly operates with the conventional spreadsheet program such that a user designing the spreadsheet would not be required to understand, review, or compose grammars since the integration module may be used to encode the digitally-enabled cells 104 for processing by the handwriting recognizer in view of the formatting and validation rules applied to the cell. For purposes of clarity, the term grammar as used herein generally refers to the study of the rules governing the use of any natural language, and, as such, is a field of linguistics or a sub-language such as the description of dates, social security numbers and other terms that have syntactic rules.

Designing a digital paper-enabled spreadsheet includes digitally enabling one or more cells of the spreadsheet and/or the entire sheet. By way of example, the digitally enabling process may include clicking on a “digitally enable” toggle button in a pull down menu of the integration module. Next and optionally, one or more cells may be merged into a single cell to provide a larger area for handwritten input to be received from the digital pen. And still next, encoding or providing instructions for the digitally-enabled cells 104 that will allow handwritten information received therein to be later converted using handwriting recognition software and also formatted in correspondence with formatting applied to the particular cell.

In one embodiment, the spreadsheet integration module utilizes a data string that conforms to the formatting syntax in the conventional spreadsheet program, split the syntax into individual components (e.g., parse out ‘m’ as month without leading zeros, parse out ‘mm’ as months with leading zeros). The module then maps each parsed piece of syntax into an equivalent grammar component (e.g., the letter ‘m’ may be mapped into a list of numbers from 1-12). With this mapping complete, the handwriting recognizer may then interpret and process the written information. For example, a user designs a cell in the spreadsheet with a custom formatting syntax of “m/d” for month/date. The module parses the syntax into three components: “m,” “/,” and “d.” The module links the “m” term to numbers 1-12 and links the “d” term to numbers 1-31. In addition, the module may generate a context-free grammar rule that instructs the handwriting recognizer to look for a number in the range of 1-12 first, followed by the “/” symbol, and then followed by a number in the range of 1-31.

Once the user has finished designing the spreadsheet 100, the user may highlight all or selected portions of the spreadsheet using a highlighter module that visually identified which cells are digitally enabled and which cells are not digitally enabled. The highlighter module permits the user to check to see if any cells were missed, whether cells that should have been merged were not merged, etc. The highlighter module may take other forms other than merely highlighting the cells, for example the highlighter module may draw borders around cells of interest or provide some other visual cue that a particular cell may require further attention from the user during the design stage.

Once designed, the spreadsheet 100 may be printed onto digital paper and handed out to one or more people. If handed out to multiple people, the spreadsheet integration module may create a digital workbook that includes a spreadsheet 100 for each person. By way of example, the spreadsheet 100 may be a survey form handed out to 15 people, thus the spreadsheet integration module would create a workbook having 15 sheets.

In another example, a user wants to record an original signature on the spreadsheet 100 so the user digitally-enables the cell 108 next to the “Signature:” labeled cell 110. In one embodiment, the cell 108 now operates to receive a signature and then displays it as a background image within the cell 108. Further, a Boolean TRUE/FALSE value may be stored in the cell 108 to indicate whether a signature was actually received in the cell 108. By way of example, a TRUE value would indicate the cell includes writing that may be a signature. By way of example, a signature validation module may be used to validate a signature within a first cell with a printed name in a second cell or vice-versa. In addition, the signature validation module may also be used to determine how many signatures exist on a spreadsheet or within a workbook of spreadsheets by including a formula that tallies the TRUE values across one or more spreadsheets.

In another embodiment, the instructions within the cells to generate a Boolean TRUE/FALSE value may be used for a variety of application. For example, the spreadsheet may be used as an image map, for example a map of a person having one or more injuries. A user of the image map could write on the spreadsheet and in each cell where ink was received, the digital pen would record a TRUE value. Writing in a knee and elbow area of the image map would trigger those respective cells to the TRUE value and indicate the person had injuries to their knee and elbow. In brief, the default value of the cells may be FALSE and the cells may be converted to TRUE when a predetermined amount of writing is received within the cells.

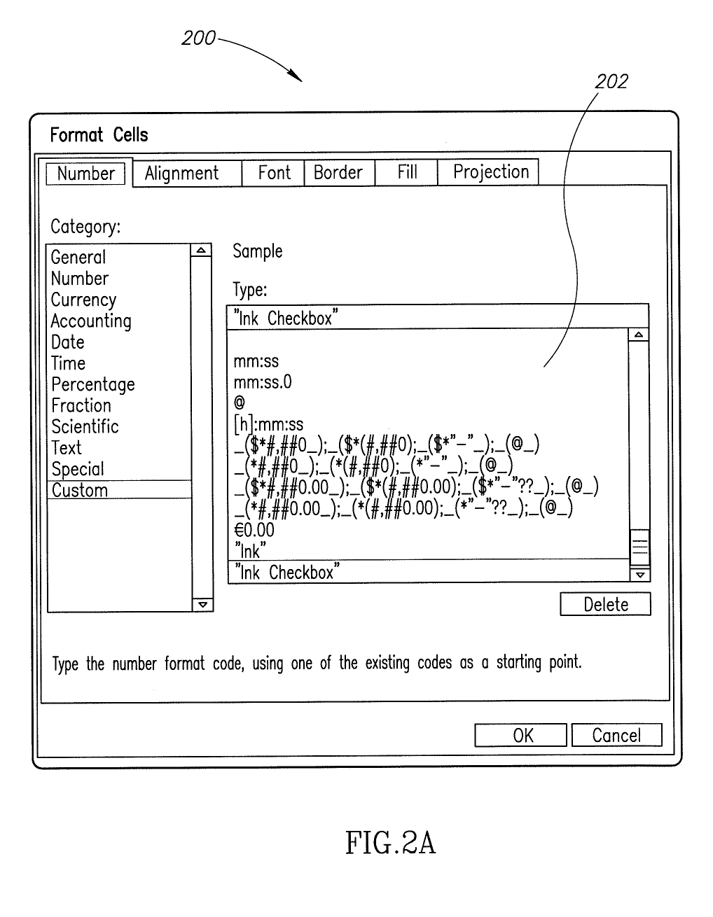

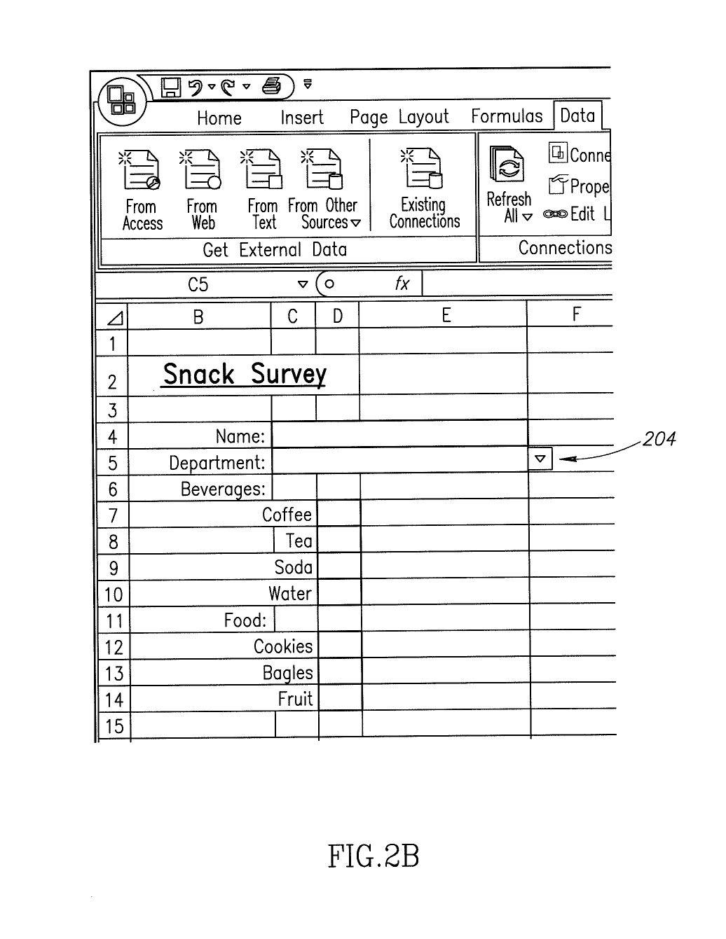

FIG. 2A shows a formatting menu 200 associated with a conventional spreadsheet program as modified by the spreadsheet integration module. For the non-digitally enabled cells 106 (FIG. 1), the user may select any cell format 202 provided by the conventional spreadsheet program. In one aspect, these cell formats 202 may be constructed with pre-defined syntax that must be converted, translated or otherwise processed by the spreadsheet integration module. By way of example, the cell formats 202 may be converted using a look up table if there is a direct match between the conventional spreadsheet formatting and a built-in grammar available in the handwriting recognition software. If the conventional spreadsheet formatting is a common format (e.g., number, date, time, etc.), then the spreadsheet integration module may dynamically construct an equivalent grammar to be used by the handwriting recognition software. If the cell includes a data validation rule pointing to a word list then the rule may include instructions for generating the grammar to be used by the handwriting recognition software.

In the illustrated embodiment, the user designs at least one digitally-enabled cell 104 (FIG. 1) to be a dropdown list 204 with associated checkboxes (FIG. 2B). When the spreadsheet 100 is printed, there are not any dropdown lists visible on the paper, but rather a regular cell with or without visible borders. The dropdown list 204 is a digital-only concept used to call a word list, which is then used to restrict the handwriting recognizer.

In another embodiment, the user may include a summary cell that is automatically generated using a formula to collect all of the TRUE values for each worksheet in the workbook. The summary cell may be designed using the “Ink Checkbox” field, which includes a Boolean value that may be set to TRUE if there is writing, such as, but not limited to a check mark, substantially within the boundaries of pre-determined digitally-enabled cells. The value may not visible inside the cell because the foreground and background color may be set to match. The Boolean value may, however, be visible in a formula textbox of the conventional spreadsheet program.

In another embodiment, one or more of the non-digitally-enabled cells may include images, pictures, symbols, or other non-alphanumeric characters as labels to identify an adjacent digitally-enabled cell.

Erasing: The spreadsheet integration module may further include an erasing module, which may take the form of an eraser icon on the printed spreadsheet. The erasing module allows users to their writing on the printed spreadsheet. The user selects the eraser icon and then simply adds new writing into a selected digitally-enabled cell. During processing, the spreadsheet integration module will ignore the first instance of writing. In one embodiment, a reviewer may be able to see both writing inputs and distinguish between them based on a color or shading of the inputs. In another embodiment, the erased writing would not be processed by the handwriting recognition software.

Printing: Referring back to FIG. 1, the spreadsheet 100 may be printed onto digital paper having a digital pattern. After printing, the electronic version of the spreadsheet 100 may be marked and stored as read-only to protect it from being changed while the printed, paper version of the spreadsheet 100 is in use.

Writing: Users will be able to write anywhere on the spreadsheet 100. However, only writing in the digitally-enabled cells 104 shall be translated using the handwriting recognition software.

Uploading: The writing applied to the printed, paper version of the spreadsheet 100 using the digital pen may be uploaded, according to one embodiment, by docking the digital pen. Docking the digital pen at least means placing the digital pen in electronic communication with the processing system. The writing may then be processed by the handwriting recognition software and placed into the appropriate cells of the spreadsheet 100 in textual form and in accordance to any formatting associated with the cell.

The data from the digital pen may be uploaded multiple times and changes made to the printed, paper version of the spreadsheet 100 after docking of the digital pen may, by default, supersede any entries before docking. Writing in the same cell from previous dockings may be retained and marked as erased if new writing is entered into the cell. Further, the spreadsheet integration module may be configured to never lose or permanently delete any writing.

Writing may be upload from the spreadsheet 100 to an alternate processing system that did not perform the printing of the spreadsheet, as long as the electronic version of the spreadsheet 100 used for printing is accessible to the alternate processing system.

The digital paper may encode information about a particular paper page address to be present on a local processing system before the writing is stored on the pen, uploaded, and then processed. For example, each printed spreadsheet may have a unique identifier or address associated with it selected spreadsheets may have the same identifier (e.g., all first pages of a notebook may have the same identifier).

Review: The spreadsheet integration module may be configured to cooperate with reviewing tools of the conventional spreadsheet program. By way of example, the spreadsheet integration module may include a tab or menu item that is selectable by a user to enter into a review session or mode. The user may selectively import the data from one or more spreadsheets. If a single digital pen is used to enter data into more than one spreadsheet, the data may be separated during importation based on a time stamp indicating when the pen was used. Once the data is imported to the processing system, which may take the form of a computer, the user may save the data at any time so that a review session may be started or completed at a later time.

In one embodiment, the data may be imported and saved for later review. In such an instance, the un-reviewed data may automatically trigger the opening of a review tab, menu or pane when the conventional spreadsheet program is used again. The review pane may be configured to permit the user to review each digitally-enabled cell by using one or more navigation buttons. Further, the review pane may be configured to permit the user to navigate in the order the cells received the written information on the paper version of the spreadsheet. For the cells that are formatted with fixed elements in the formula (e.g., social security numbers, telephone numbers, addresses, etc.), the review module will present the user with those fixed elements as static text surrounded by the appropriate data entry fields.

During review of the spreadsheet a reviewer may notice that the written information in one of the cells was not processed or processed incorrectly. The review module permits the reviewer may implement or invoke cell formatting and/or validation rules for that cell to digitally enable the cell so the writing therein may be interpreted. The reviewer may apply the rules to one or more cells, for example to cells in other spreadsheets contained in a workbook.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A digital paper-enabled spreadsheet system comprising:
a digital paper document bearing a digital pattern; and
a plurality of input cells in a spreadsheet form overlaid on at least a portion of the digital pattern, a first input cell of the plurality of input cells is operable to receive handwritten information that is translatable to digital information based on processing rules associated with the first cell.

2. The system of claim 1, wherein the handwritten and digital information of a particular input cell are movable to a different location within the spreadsheet.

3. The system of claim 1, further comprising:
a signature validation module operable within the first cell and within a second cell, the first cell receiving a printed name, the second cell receiving an actual signature, the signature validation module using the printed name to validate the actual signature.

4. The system of claim 1, further comprising:
a signature validation module operable within the first cell and within a second cell, the first cell receiving a printed name, the second cell receiving an actual signature, the signature validation module using the actual signature to validate the printed name.

5. The system of claim 1, further comprising:
an evaluation module for analyzing a design of the spreadsheet as a digital paper input document.

6. The system of claim 1, wherein at least one of the cells includes instructions to limit the handwritten information received in the cell using a drop down list.

7. The system of claim 6, wherein items from the drop down list are located in one or more cells and are selectable when writing is received in checkboxes located proximate the one or more cells.

8. The system of claim 1, further comprising:
a formatting detection module operable to suggest a format to be applied to the cell when processing the digital information.

9. A method of designing a digital paper-enabled spreadsheet in cooperation with a conventional spreadsheet program, the method comprising:
selecting a cell from a plurality of cells arranged to form the spreadsheet;
applying a desired formatting rule to the cell, the formatting rule selected from a set of formatting rules available from the conventional spreadsheet program; and
digitally enabling the cell to make the cell operable to receive written information from a digital pen, wherein digitally enabling the cell associates the written information received in the cell with a digital pattern underlying the spreadsheet after the spreadsheet is printed.

10. The method of claim 9, further comprising:
toggling a display to show all cells at least within a viewable area of the spreadsheet that have been digitally enabled.

11. The method of claim 10 wherein toggling the display includes highlighting cells that do not have a formatting rule applied thereto.

12. A method of processing a digital paper-enabled spreadsheet, the method comprising:
writing information in a cell of the digital paper-enabled spreadsheet with a digital writing instrument;
uploading the data stored in the digital writing instrument that corresponds to the written information, wherein uploading includes transmitting the written information to a computational processing system;
interpreting formatting and validation rules applied to the cell;
processing the written information using a handwriting recognizer in cooperation with grammar rules that were generated based on the formatting and validation rules; and
converting the written information to digital information.

13. The method of claim 12 wherein writing information with the digital writing instrument includes writing the instrument with a digital pen.

14. The method of claim 12, wherein uploading the data stored in the digital writing instrument includes placing the writing instrument in signal communication with a processing system.

15. The method of claim 12, further comprising:
determining an identifier of the digital writing instrument in which the identifier corresponds to a unique identifier for a particular user of the writing instrument; and
selecting a handwriting profile for the particular user based on the identifier of the writing instrument.

16. The method of claim 15, further comprising:
selecting a dictionary for the particular user based on the identifier of the writing instrument, the dictionary customized for the particular user.
